(19) United States
(12) Patent Application Publication
(10) Pub. No.: US 2006/0238996 A1
(43) Pub. Date: Oct. 26, 2006

(54) Formicarium illuminator

(76) Inventor: William G. Hones, Seattle, WA (US)

Correspondence Address: ROBERT W. J. USHER;PATENT AGENT, 1133 BROADWAY, #1515, NEW YORK, NY, 10010, US

(21) Appl. No.: 11/191,373

(22) Filed: Jul. 27, 2005

Related U.S. Application Data
(63) Continuation of application No. 11/111,010, filed on Apr. 21, 2005, now abandoned.

(51) Int. Cl. F21V 33/00; A47B 97/00

(52) U.S. Cl. 362/127

(57) ABSTRACT

A light fitting accessory for a transparent walled formicarium filled with clear, ant-nutritious tunneling gel. The formicarium has a basal cavity formed by a base wall raised within the sidewalls and the accessory housing is received as a manual push fit in the cavity enabling easy, modification free, retrofit of the accessory to form a single unit with the formicarium. Walls of the housing incline together towards a top providing a wedge shape and have external surfaces formed with vertically extending friction ribs which frictionally engage cavity walls of the formicarium. The housing mounts narrow beam LEDs shining upwardly into the formicarium and concealed below a front, opaque wall of the housing.

### FIELD OF THE INVENTION

The invention relates to formicaria and more particularly to a light fitting accessory for illuminating a formicarium.

### BACKGROUND OF THE INVENTION

Formicaria for housing and observing ant nests have been well known for many years. Such formicaria have often comprised transparent major front and rear walls upstanding in opposed, closely spaced relation from a transparent base and connected at respective opposite longitudinal ends by respective end walls providing a container to enable the activities of tunneling ants to be seen through the front wall. Such formicaria have been filled with a nutritious, colorless or clear, transparent gel medium, which provides the entire source of food and water for the ants and through which they tunnel and can be observed although the width of the container is equal to the widths of several ant tunnels. More recently, to facilitate convenient viewing, one type of formicarium, (also prior art), has been molded in one piece with a base wall raised within the front, rear and end walls, forming an open bottomed base cavity with corresponding cavity wall portions formed as continuations of lower portions of the front, rear and end walls.

It is often desirable to illuminate formicaria more clearly to see the ants in their tunnels, especially in artificial lighting or at night or, when the gel may have slight cloudiness. As back lighting may shine in the observer's eyes and top lighting may be scattered by gel tailings deposited by the ants on the top surface of the gel, bottom lighting is preferred. However, the provision of artificial lighting itself adds expense and, problems can arise in mounting lamps on the formicarium effectively and inexpensively.

It is therefore desirable to provide an illuminator as an optional item which can be sold separately from the formicarium, does not require modification of the formicarium structure and when purchased subsequently can be retro fitted to the formicarium by the consumer to provide a unitary structure and without need of subsequent modification.

Although U.S. Pat. No. 6,447,138 issued September 2002 to Yang and U.S. Pat. No. 6,135,604 issued October 2000 to Lin teach illumination of aquaria and water lamps from below, as the lighting compartments located under the water containers include associated components that extend through the bases into the water containers, the lighting fittings located under the water containers cannot be safely retro fitted by the consumer as they must be absolutely water tight to eliminate risk of leakage, with risk of short circuit and personal injury, therefore normally requiring factory sealing.

### SUMMARY OF THE INVENTION

An object of the invention is to provide lighting for a formicarium of the above type as an optional item which can be sold separately from the formicarium, does not require modification of the formicarium structure and yet can be easily retro fitted with the formicarium without any modification thereof whatsoever to provide a unitary structure.

According to one aspect, the invention provides a light fitting accessory for a formicarium of the type described above comprising a lamp housing having an elongate opaque front wall and an elongate opaque rear wall joined by a transverse wall to extend in opposed spaced apart relation providing between them a lamp receiving compartment, the front wall and the rear wall having adjacent respective elongate edges defining a top of the compartment and, at least one light aperture at the top, at least one lamp device mounted in the compartment between the front and rear walls and, friction means on an outer surface of the front wall and on an outer surface of the rear wall for frictional engagement with an inner surface of the front wall and an inner surface of the rear wall of the base cavity,

so that the housing can be inserted top first into the base cavity through the open bottom and retained press fitted in the base cavity forming a unit with the formicarium by the frictional engagement, with lamp light shining upward through said at least one aperture from the top of the housing through the transparent base wall of the formicarium illuminating the gel therein.

Thus, the light fitting accessory need not be assembled/incorporated with the formicarium when the formicarium is initially sold, but can be offered optionally as a retro fitted item. Furthermore, no structural modification whatsoever of the formicarium is required for retro fit of the light fitting accessory which is accomplished manually by a simple push fit action, without need of any tool, to provide a structure which is, nevertheless, unitary with the formicarium. Such is the simplicity of assembly that the light fitting accessory can be retro fitted to a formicarium already containing ants tunneling in a gel medium.

Preferably, the friction means comprises at least one protuberance formed on an outer surface of at least one of the front wall and rear wall.

It is further preferred that said at least one protuberance comprises a plurality of vertically extending ribs.

It is also preferred that the front and rear walls incline towards each as they extend towards the top providing a wedge shape.

In one embodiment, the lamp device is mounted no higher than the front wall so as to be concealed from view from a front.

Preferably, the lamp device comprises at least one LED, the directional light emitting properties of which are strongly directional so that the light shines upwardly through the medium with relatively little side emission to interfere with viewing.

The front, rear and transverse walls form a base member of the lamp housing, said at least one lamp device comprises a plurality of light emitting diodes mounted at longitudinally spaced apart intervals on a circuit board and, the lamp housing further comprises an elongate cover member formed with a plurality of apertures at longitudinally spaced apart intervals corresponding to the intervals of the light emitting diodes on the circuit board and the cover member being mounted on the base member covering the lamp receiving compartment so that said longitudinally spaced apart apertures register with respective apertures in the cover member.

The circuit board may comprise a power supply circuit having two power input poles for connection to an external domestic A.C. power supply and comprising first and second rectifying diodes connected in a same sense between one input pole and respective poles of a set of light emitting diodes (LED) and, third and fourth rectifying diodes respectively, connected in the same sense between the other input pole and respective poles of the LED set to ensure current flow to all LEDs in only a single correct direction and so that the first and the fourth diodes turn on during one half cycle and the second and the third diodes turn on during an opposite half cycle providing forming a full wave bridge rectifier permitting current flow to operate the LEDs for both opposite, half cycles.

### BRIEF DESCRIPTION OF THE DRAWINGS

In order that the invention may be readily understood, specific embodiments thereof will now be described with reference to the accompanying drawings in which:

FIG. 1 is a front perspective view of a formicarium;

FIG. 2 is a front perspective view of a light fitting accessory;

FIG. 3 is a rear perspective view of the light fitting accessory;

FIGS. 4-8 are, respectively, a rear side elevation; top plan view; end elevation, underplan view; and cross-sectional view taken along line 8-8 of FIG. 5 of a base member of the light fitting accessory;

FIGS. 9-11 are, respectively, an underplan view; cross-sectional view along line 10-10 of FIG. 9; and, a top plan view of a cover of the light fitting accessory rear side elevation; top plan view; end elevation, underplan view; and cross-sectional view taken along line 8-8 of FIG. 5 of a cover member of the light fitting accessory;

FIG. 12 is a plan view of a lamp device of the light fitting accessory formed by a circuit board mounting light emitting diodes;

FIG. 13 is a circuit diagram of the lamp device;

FIG. 14 is a perspective view of another embodiment of the light fitting accessory during assembly with a formicarium by insertion into a base cavity thereof;

FIG. 15 is a perspective view of a modified light fitting accessory assembled with the formicarium by insertion into the base cavity;

FIG. 16 is an perspective view from below of the modified light fitting accessory assembled with the formicarium by insertion into the base cavity;

FIG. 17 is a front view of a working formicarium illuminated by the modified light fitting accessory assembled therewith; and

FIG. 18 is a perspective view of an ant sculpture illuminated by the light fitting accessory.

### DESCRIPTION OF PARTICULAR EMBODIMENTS

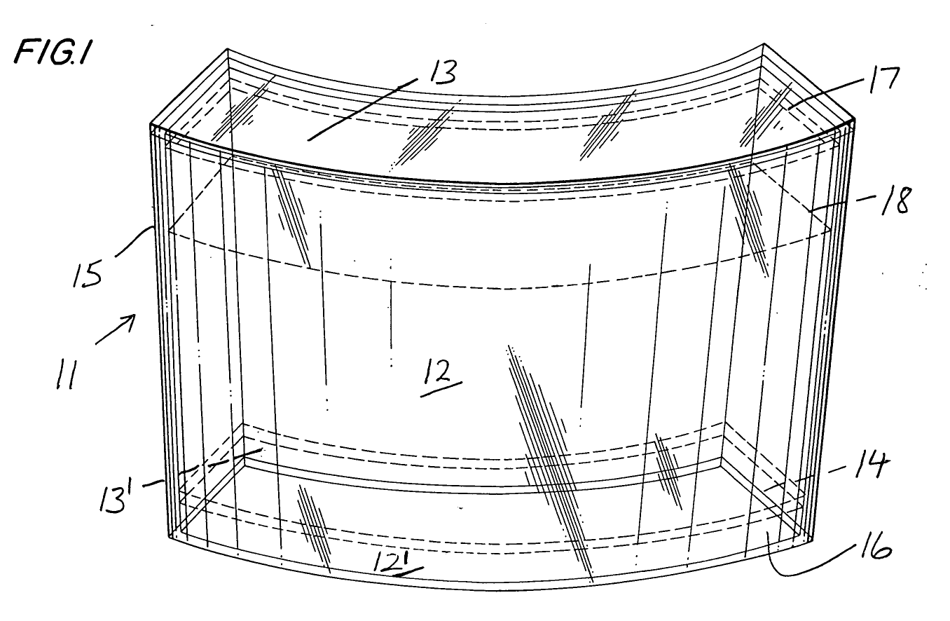

As shown particularly in FIG. 1, a formicarium 11 is molded in one piece from high impact transparent plastic (polyethylene) and comprises transparent major front and rear walls 12 and 13, respectively, upstanding in opposed, closely spaced relation from a transparent base wall 14 and connected at respective opposite longitudinal ends by respective end walls 15 providing a container having a width of several times the width of ant-tunnels. The base wall 14 is raised within the front, rear and end walls, forming an open bottomed base cavity 16 with corresponding front, rear and end cavity wall portions 12′, 13′ and 15′, respectively, formed by continuations of lower portions of the front, rear and end walls. A closure member 17 perforated by a small air hole seats on the open top. The formicarium is arcuate subtending an angle of 60 degrees so that six may be positioned together end to end in an unbroken circular ring. The container interior is filled to the level 18 by a transparent, ant-nutritious, gel medium.

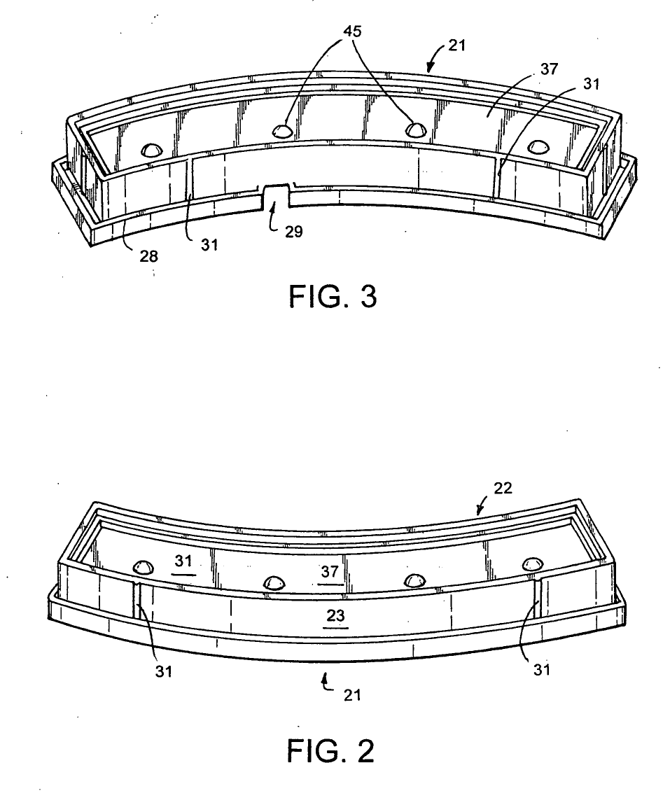

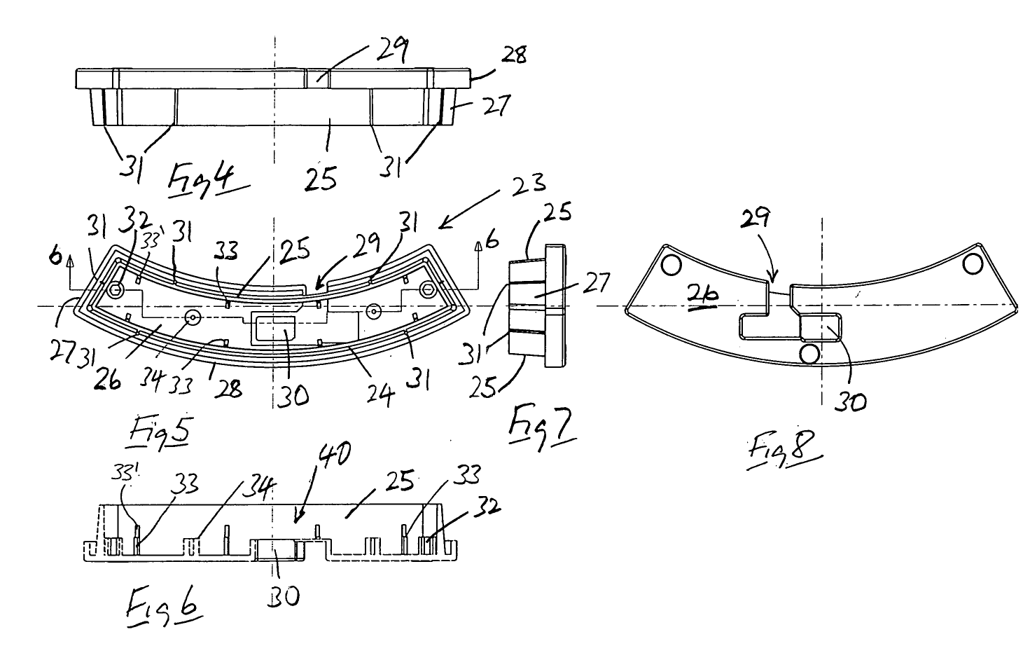

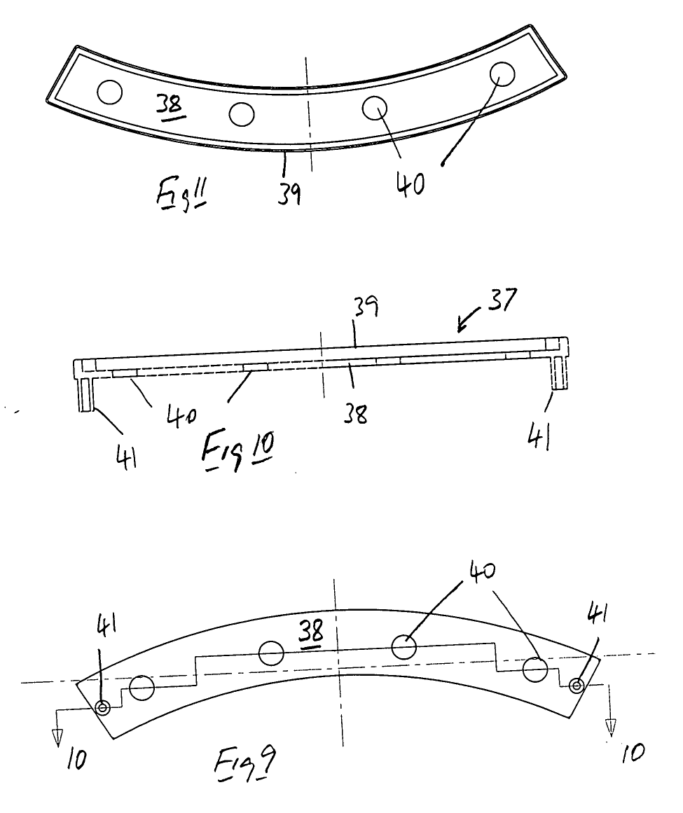

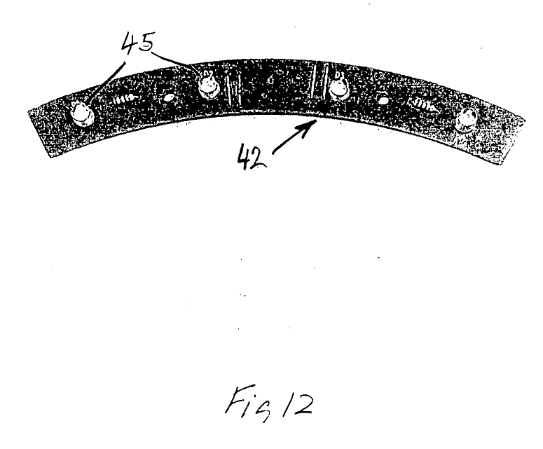

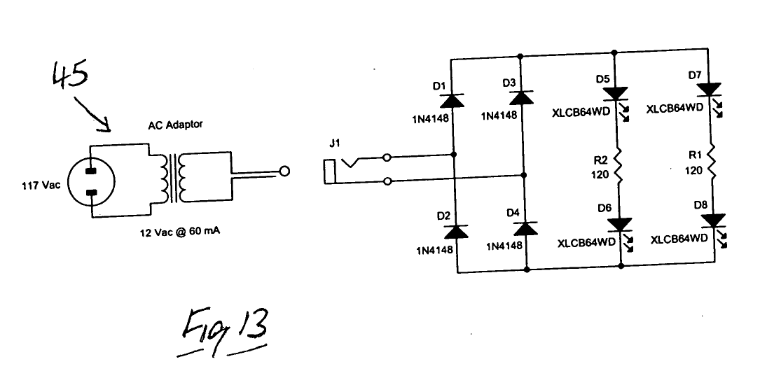

As shown in FIG. 2-11, the light fitting accessory 21 comprises a lamp housing 22 comprising a base member 23, (FIGS. 4-8), a cover member 37 (FIGS. 9-11) and a lamp device 42 enclosed therein.

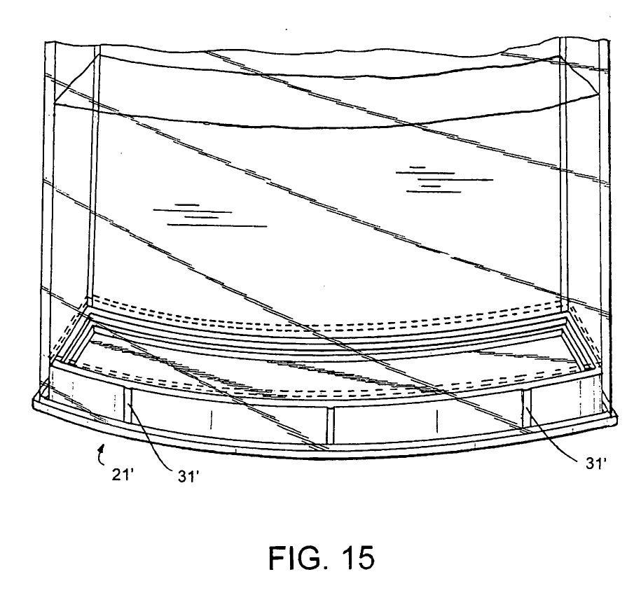

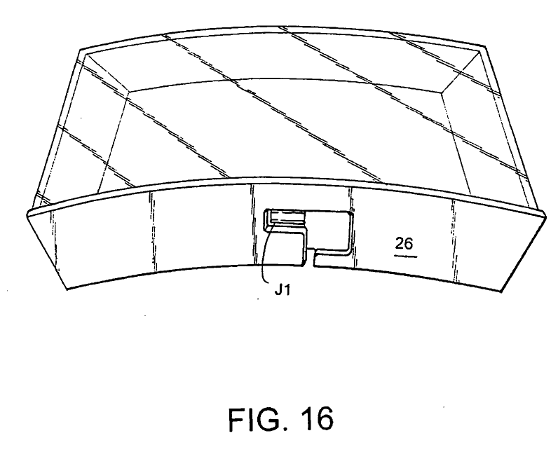

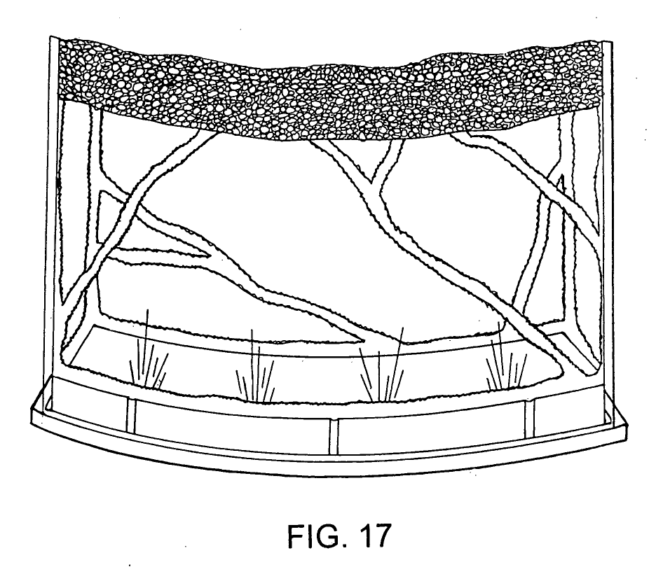

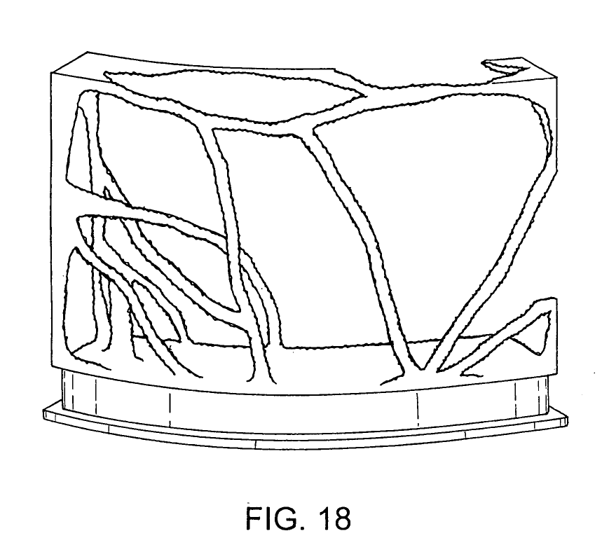

The base member 23, (FIG. 4-8), is arcuate, corresponding to the footprint of the formicarium and molded in one piece of opaque plastic material, and comprises elongate, arcuate, and rear walls 24 and 25, respectively, upstanding from a bottom wall 26 and joined by planar transverse walls 27 to extend in opposed spaced apart relation providing between them a lamp receiving compartment 40, with upper edges of the walls defining a top of the compartment. A rim wall 28 upstands from the perimeter of the bottom wall except at an aperture 29 for an electrical lead which communicates with a jack receiving recess 30 shown in FIG. 15. Two vertically extending friction ribs 31 are formed on respective outer surfaces of each of the front and rear walls, and one friction rib 31 on each of the end walls 27.

Mounting pin receiving sockets 32 upstand from the bottom wall 26 adjacent respective longitudinal ends. Circuit board supports are formed by ledges formed near upper ends of vertical ribs 33 formed on inside surfaces of the front and rear walls 24 and 24 with the rib portions 33′ above the ledges providing a close or friction fit with a cover assembled therein. Circuit board mounting screw sockets 34 also upstand from the bottom wall at the same level.

The cover member 37, (FIG. 9-11) is molded in one piece of opaque plastic material and comprises a main, flat panel 38 bounded by and upstanding rim wall 39 and formed with four equi-spaced apart apertures 40. Hollow mounting pins 41 depend from opposite longitudinal ends of the panel 38.

The lamp device 42, (FIG. 12), comprises a circuit board 43 shaped for receipt in the base member 23 and mounting four light emitting diodes (L.E.D.) 45 thereon at equi-spaced apart intervals corresponding to the spacings of the apertures 40 in the cover member 37.

As shown in FIG. 13, the circuit for the lamp device comprises two power input poles connected to terminals of a jack J1, (mounted on the underside of the circuit board), for mating receipt of a plug of a step down transformer 45 connected to a external domestic A.C. power supply. First and second rectifying diodes D1, D2, respectively, are connected in a same sense between one input pole and both poles of a set of four LED D5, D6, D7 and D8 arranged as two, parallel, subsets of series connected pairs D5, D6 and D7, D8, respectively and, third and fourth rectifying diodes D3 and D4, respectively, connected in the same sense between the other input pole and both poles of the LED set to ensure current flow to all LEDs in only a single correct direction. The diodes of each subset are connected by resistors R1 and R2. Thus, D1 and D4 will turn on during one half cycle and D3 and D2 will turn on during the opposite half cycle forming a full wave bridge rectifier permitting current flow to operate the LEDs for a complete cycle. Any pause in illumination during switch-over is not normally noticed because of the after image or persistence of image effect and for most people there is an impression of a continuous light. The circuit will also operate the LEDs when connected to a D.C. source. Current is conducted continuously through either D1, D4 or D2, D3 according to the polarity of connection.

The light fitting accessory is assembled, by inserting and attaching the assembled circuit board with jack by screws into the compartment 40 in the base member 23 so that the circuit board is seated on the ledges and the jack is received in recess 30. The cover member 37 is then pushed into the compartment forming a force fit with the upper end portion 33′ of the friction ribs 33 and with and the pins 41 plugged into the sockets 32.

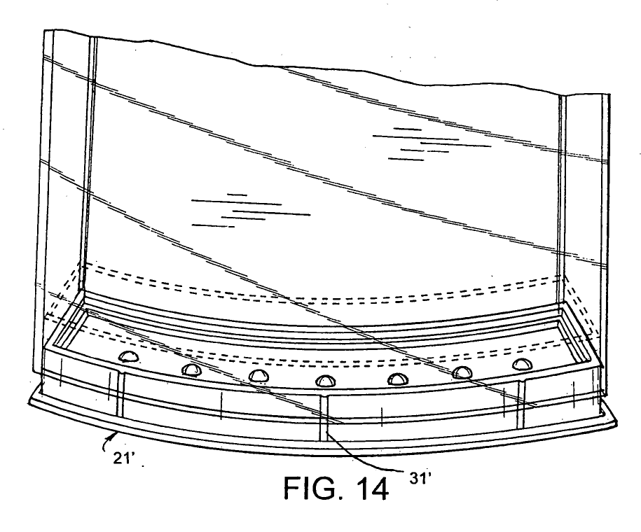

The consumer assembles the light fitting accessory with the formicarium by simply manually pushing it into the basal cavity, as shown with the modified light fitting accessory 21′ of FIG. 14, (which has eight LEDs. and three friction ribs 31′ on front and rear walls), until bottom edges of the formicarium wall portions sit on the rim wall 28 when the ribs 31′ frictionally engage the inside surfaces of the front and rear wall portions to retain the light fitting accessory in the cavity as a force fit. No tools or modification of either part is required. A plug terminating a transformer fitting accessory can then be inserted in to the jack and the transformer plugged into a standard domestic socket.

The consumer can form the ant tunnel network into a sculpture by removing the ants, clearing the top surface of the gel of tailings, inverting the formicarium and removing (by shaking out) the tunneled gel as a body, into another, frangible or break-apart, container of the same size and shape for support, spreading a flowable transparent epoxy cement onto the surface and permitting the epoxy to flow into and fill the labyrinth of tunnels in the gel. The epoxy sets hard in the ant tunnels as a network of limbs molded to their precise shapes. The container is then broken off the epoxy-gel mass and the gel washed away leaving an ant sculpture comprising a network of branches of solid, transparent epoxy molded by the tunnel walls of the network to and with a flat epoxy base formed by the surface layer of epoxy.

As the inserted part of the housing corresponds in cross-section to the interior of the formicarium, the light fitting accessory housing can also provide an illuminating stand for the ant sculpture, as shown in FIG. 18. It will be noticed that the light is preferentially scattered from the outer surfaces of the epoxy branches as a result of the surface unevenness and irregularities produced by the action of the ants mandibles biting the gel when forming the tunnel walls.

1. A light fitting accessory for a formicarium of a type comprising a transparent major front wall and a transparent major rear wall upstanding in opposed, closely spaced relation from a transparent base wall and connected at respective opposite longitudinal ends by respective end walls providing a container filled with a transparent medium of ant-nutritious gel to enable activities of tunneling ants to be seen through the front wall, the base wall being raised within the front, rear and end walls, forming an open bottomed, base cavity with corresponding cavity wall portions formed as continuations of lower portions of the front, rear and end walls;
the light fitting accessory comprising a lamp housing having an elongate front wall and a rear wall joined by a transverse wall to extend in opposed spaced apart relation providing between them a lamp receiving compartment, the front wall and the rear wall having adjacent respective elongate edges defining a top of the compartment and, at least one light aperture at the top, at least one lamp device mounted in the compartment between the front and rear walls and, friction means on an outer surface of the front wall and on an outer surface of the rear wall for frictional engagement with an inner surface of the front wall portion and an inner surface of the rear wall portion of the base cavity,
so that the housing can be inserted top first into the base cavity through the open bottom and retained press fitted in the base cavity by the frictional engagement to form a single unit with the formicarium and with lamp light shining upward through said at least one aperture from the top of the housing through the transparent base wall of the formicarium, illuminating the gel and ants tunneling through-out the medium.

2. A light fitting accessory according to claim 1 wherein the friction means comprises at least one protuberance formed on an outer surface of at least one of the front wall and rear wall.

3. A light fitting accessory according to claim 2 wherein said at least one protuberance comprises a plurality of vertically extending ribs.

4. A light fitting accessory according to claim 3 wherein the front and rear walls incline towards each as they extend towards the top providing a wedge shape.

5. A light fitting accessory according to claim 4 wherein the front, rear and transverse walls form a base member of the lamp housing, said at least one lamp device comprises a plurality of light emitting diodes forming a set and mounted at longitudinally spaced apart intervals on a circuit board and, the lamp housing further comprises an elongate cover member formed with a plurality of apertures at longitudinally spaced apart intervals corresponding to the intervals of the light emitting diodes on the circuit board and the cover member being mounted on the base member covering the lamp receiving compartment so that said longitudinally spaced apart apertures register with respective apertures in the cover member.

6. A light fitting accessory according to claim 4 wherein at least a front wall of the lamp housing is opaque and said at least one lamp device is no higher than the front wall so that light therefrom is concealed from view from a front.

7. A light fitting accessory for a formicarium of a type comprising a transparent major front wall and a transparent major rear wall upstanding in opposed, closely spaced relation from a transparent base wall and connected at respective opposite longitudinal ends by respective end walls providing a container filled with a transparent medium of ant-nutritious gel to enable activities of tunneling ants to be seen through the front wall, the base wall being raised within the front, rear and end walls, forming an open bottomed, base cavity with corresponding cavity wall portions formed as continuations of lower portions of the front, rear and end walls;
the light fitting accessory comprising a lamp housing having an elongate front wall and a rear wall joined by a transverse wall to extend in opposed spaced apart relation providing between them a lamp receiving compartment, the front wall and the rear wall having adjacent respective elongate edges defining a top of the compartment and, at least one light aperture at the top, at least one lamp device mounted in the compartment between the front and rear walls and, friction means on the front wall and on the rear wall for frictional engagement with a surface of the front wall portion and a surface of the rear wall portion of the base cavity, respectively,
so that the lamp receiving compartment can be inserted top first into the base cavity through the open bottom and retained press fitted in the base cavity by the frictional engagement to form a single unit with the formicarium and with lamp light shining upward through said at least one aperture from the top through the transparent base wall of the formicarium, illuminating the gel and ants tunneling through-out the medium.
